(19) United States
(12) Patent Application Publication
(10) Pub. No.: US 2011/0310966 A1
(43) Pub. Date: Dec. 22, 2011

(54) SYNTAX ELEMENT DECODING

(75) Inventor: Jagadeesh SANKARAN, Allen, TX (US)

(73) Assignee: TEXAS INSTRUMENTS INCORPORATED, Dallas, TX (US)

(21) Appl. No.: 12/818,652

(22) Filed: Jun. 18, 2010

(51) Int. Cl. H04N 7/26; H04N 7/32

(52) U.S. Cl. 375/240.12; 375/240.25; 375/E07.027

(57) ABSTRACT

Techniques for efficient syntax element decoding in a system employing context-based adaptive binary arithmetic decoding are disclosed herein. In some embodiments, a video decoding system includes a context-based adaptive binary arithmetic code (“CABAC”) decoder. The decoder includes a processor and decode logic executed by the processor. The decode logic is configured to decompress a CABAC encoded syntax element. The decode logic includes a table embodying a set of rules that determine whether syntax element decoding is complete based on table addressing derived from a decoded syntax element binary value.

### BACKGROUND

The H.264 video coding standard promulgated by the International Telecommunication Union, offers two entropy coding options: context-based adaptive variable length coding (“CAVLC”) and context-based adaptive arithmetic coding (“CABAC”). CABAC can provide a substantial bit-rate savings over CAVLC, but is more computationally complex.

Macroblock type is one of a number of different syntax elements included in a CABAC bitstream. A macroblock generally refers to a 16×16 pixel block. A macroblock type syntax element identifies various parameters of a macroblock (e.g., macroblock partitioning, prediction mode, etc). Macroblock type semantics are dependent on the slice type, where a slice is a set of consecutively ordered macroblocks. An I slice uses only intra slice prediction. A P slice uses intra slice prediction or inter prediction applying one motion vector. A B slice uses intra slice prediction or inter prediction applying two motion vectors.

The H.264 standard defines the binarization of macroblock type in accordance with slice type. The unstructured and complex macroblock type codes specified by the H.264 standard can result in poor decoding efficiency when decoding is performed by general-purpose processors.

### SUMMARY

Techniques for efficient macroblock type decoding in a system employing context-based adaptive binary arithmetic decoding are disclosed herein. In some embodiments, a video decoding system includes a context-based adaptive binary arithmetic code (“CABAC”) decoder. The decoder includes a processor and decode logic executed by the processor. The decode logic is configured to decompress a CABAC encoded syntax element. The decode logic includes a table embodying a set of rules that determine whether syntax element decoding is complete based on table addressing derived from a decoded syntax element binary value.

In other embodiments, a method includes determining, by one or more processors, a type of syntax element to be decoded from a CABAC encoded bitstream. A bit is decoded from the bitstream, by the one or more processors, based on the determined type of syntax element. A syntax element binary value is generated, by the one or more processors, based on the decoded bit. An indication of syntax element decoding completion is retrieved from a table by the one or more processors. The table embodies rules for determining whether syntax element decoding is complete based on a sequence of decoded syntax element bits.

In yet other embodiments, a computer readable medium is encoded with a computer program. When executed the program causes a processor to determine a type of syntax element to be decoded from a CABAC encoded bitstream. The program also causes the processor to decode a bit from the bitstream based on the determined type of syntax element. The program further causes the processor to generate a syntax element binary value based on the decoded bit. The program yet further causes the processor to retrieve an indication of syntax element decoding completion from a table embodying rules for determining whether syntax element decoding is complete. The determining is based on a sequence of decoded syntax element bits.

### BRIEF DESCRIPTION OF THE DRAWINGS

For a detailed description of exemplary embodiments of the invention, reference will now be made to the accompanying drawings in which:

FIG. 1 shows a block diagram of a video system using context-based adaptive binary arithmetic coding (“CABAC”) that includes macroblock type decoding in accordance with various embodiments;

FIG. 2 shows a block diagram of a CABAC macroblock type decoder in accordance with various embodiments;

FIG. 3 shows a macroblock type decoding table for CABAC macroblock type decoding in accordance with various embodiments; and

FIG. 4 shows a flow diagram for a method for CABAC macroblock type decoding in accordance with various embodiments.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. Further, the term “software” includes any executable code capable of running on a processor, regardless of the media used to store the software. Thus, code stored in memory (e.g., non-volatile memory), and sometimes referred to as “embedded firmware,” is included within the definition of software.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Various techniques for decoding a syntax element (e.g., macroblock type) of a bitstream encoded using context-based adaptive binary arithmetic code (“CABAC”) are disclosed herein. Decoding a bit from a CABAC encoded bitstream includes the selection of a context model for application to the decoding, generating a bit based on the context model and the bitstream, inserting the bit in a symbol binary, and updating the context model. When a complete syntax element binary value is acquired, reverse binarization is applied to determine the syntax element symbol.

Processors with multiple execution units, such as very long instruction word (“VLIW”) processors, can use software pipelining to improve the efficiency of algorithm execution. To make optimal use of software pipelining, changes of execution context, such as branches and calls, should be minimized. Syntax element decoding via traversal of a binarization code tree can result in numerous changes in execution context, and correspondingly poor decoding efficiency. Some CABAC decoding systems include a number and/or frequency of calls and/or conditional statements that prevent any software pipeline in a decoding loop.

Embodiments of the present disclosure provide improved decoding efficiency through the use of decoding rules that control various aspects of syntax element decoding while reducing changes in execution context. Use of decoding rules allows embodiments to incorporate various calls and conditional statements in a decoding loop thereby providing a large unconditional instruction stream that is amenable to software pipelining.

In some embodiments, macroblock decoding rules are embodied in a rule table that is accessed based on the current binary value of macroblock type element being decoded. Based on the current binary value of a macroblock type, embodiments of a macroblock type decoding rule table may provide information indicating whether decoding is complete, a number of additional bits to decode, a context model to apply for decoding a next bit, and a macroblock type symbol value. Embodiments are discussed herein with reference to macroblock type decoding. However, embodiments of the present disclosure include tables of decoding rules for decoding various syntax elements, such as macroblock type, sub-macroblock type, chroma prediction mode, intra prediction mode, etc. By providing multiple context models across bins in addition to the decoding rules, embodiments may provide 8-10 times the decoding performance of non-pipelined system.

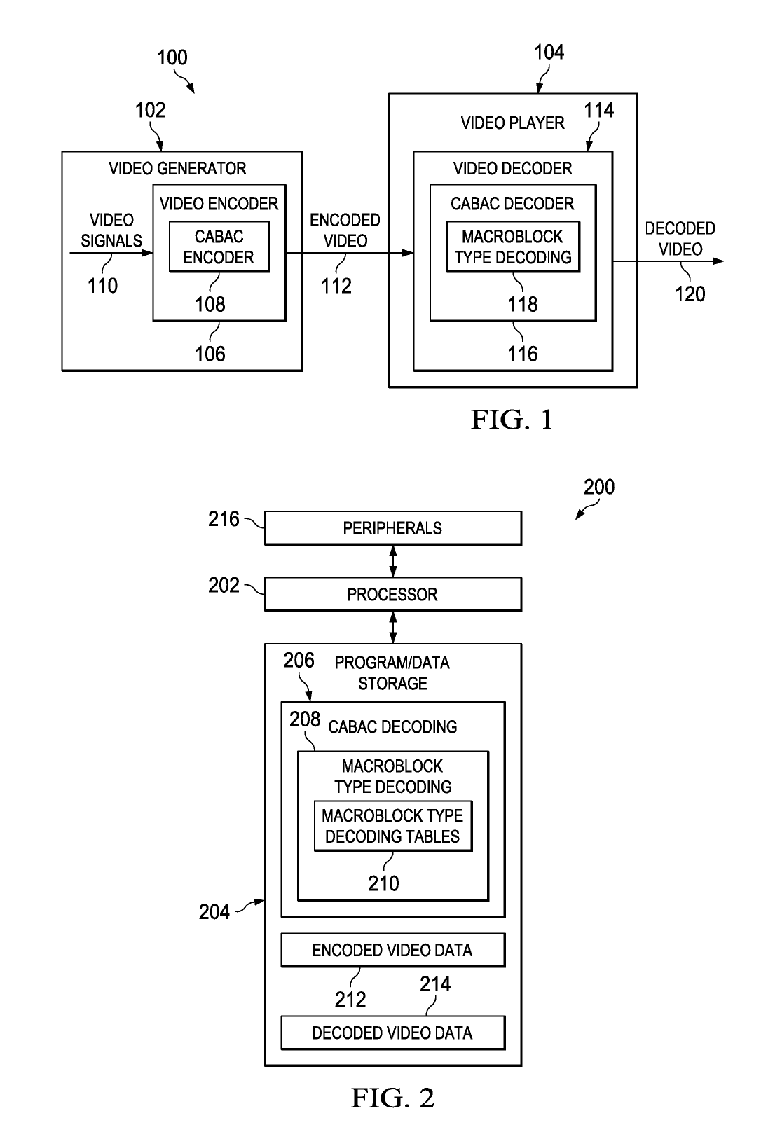

FIG. 1 shows a block diagram of a video system 100 using CABAC that includes macroblock type decoding in accordance with various embodiments. The video system 100 includes a video generator 102 and a video player 104. The video generator 102 includes a video encoder 106 that further includes a CABAC encoder 108. The video encoder 106 (e.g., an H.264 encoder) receives video signals 110, performs motion estimation, prediction, transformation, quantization, and various other functions.

Quantized video data is provided to the CABAC encoder 108 for compression. The CABAC encoder 108 selects an appropriate context model for each symbol (i.e., each syntax element or element of data to be represented in the bitstream 112) (e.g., quantized transform coefficients, prediction information, etc.) to be encoded. Context models provide probability estimates for coding symbols. If a symbol is non-binary, the CABAC encoder maps the symbol to a sequence of bits in a process referred to as binarization. Each bit is encoded using adaptive binary arithmetic coding based on probability estimates provided from the context modeling or binarization operations. After the arithmetic coding, the context model is updated based on the encoded binary symbol.

The encoded bitstream 112 comprising the compressed video data is transferred to the video player 104. Various transport media are suitable to transfer of the bitstream 112. For example, optical or magnetic storage media, semiconductor storage, or wired or wireless networks may be used to transfer the bitstream 112.

The video player 104 includes a video decoder 114. The video decoder 114 further includes a CABAC decoder 116 that includes macroblock type decoding 118 in accordance with the present disclosure. The video decoder 114 receives the compressed video bitstream 112, and provides the bitstream 112 to the CABAC decoder 116 for decompression. The CABAC decoder 116 selects a context model for each bit to be generated from the bitstream 112 and generates a bit based on the bitstream 112 and model. The model is updated based on the generated bit and bits are combined to form a symbol binary. The binarization performed in the CABAC encoder 108 is reversed to produce a symbol.

Symbols forming quantized transform coefficients generated by the CABAC decoder 118 are re-scaled and an inverse transform is applied. Predication is applied to reconstruct the macroblocks forming a frame of video.

Embodiments of the CABAC decoder 116 apply the macroblock type decoding logic 118 to accelerate decoding of macroblock type information included in the compressed bitstream 112. The macroblock decoding logic 118 improves the efficiency of decoding macroblock type syntax elements on a processor including multiple execution units by reducing the number of context switches through rules that guide decoding, thereby allowing effective use of software pipelining in a decoding loop. The rules guiding macroblock type decoding may be embodied in the instructions of software programming or in a table referenced by such instructions. The rules may direct macroblock type decoding software as to whether decoding is complete, a number of additional bits to decode, context model to be applied, macroblock type symbol, etc.

FIG. 2 shows a block diagram of a CABAC macroblock type decoder 200 in accordance with various embodiments. The decoder 200 includes a processor 202 and program/data storage 204. The processor 202 may be a general-purpose processor, a digital signal processor, a microcontroller, etc. Processor architectures generally include execution units (e.g., fixed point, floating point, integer, etc.), storage (e.g., registers, memory, etc.), instruction decoding, peripherals (e.g., interrupt controllers, timers, direct memory access controllers, etc.), input/output systems (e.g., serial ports, parallel ports, etc.) and various other components and sub-systems. The processor 202 preferably includes multiple execution units configured for simultaneous operation, as in, for example the TMS320C6x by Texas Instruments. The processor 202 may be a VLIW processor, and instruction generation for the processor 202 may provide software pipelining. Some embodiments of the system 200 include multiple processors 202.

The program/data storage 204 is a computer-readable medium coupled to the processor 202. The storage 204 may include one or more of volatile or non-volatile semiconductor memory (e.g., static/dynamic random access memory, read-only-memory, FLASH memory, etc.), magnetic storage (e.g., hard disk), or optical storage (e.g., compact disc, digital versatile disc, etc). Software programming executable by the processor 202 may be included in the storage 204 (e.g., the CABAC decoding 206). The storage 204 may also include data to be processed by the processor 202, and/or data produced as a result of operations performed by the processor 202. For example, encoded video data 212 is stored in the storage 204 for decoding, as is decoded video data 214 produced by operation of the decoder 200.

The system 200 may also include various peripheral systems 216 coupled to the processor 202. Such peripheral systems may include communication systems allowing transmission and reception of data via wired and/or wireless communication channels. In some embodiments, video data to be processed by the CABAC decoding module 206 is received via such communication channels. Displays and user entry devices are examples of the peripheral systems that may be included in the system 200.

The CABAC decoding module 206 may be included in a video decoding program executable by the processor 202. When executed, the instructions of the CABAC decoding module 206 cause the processor 202 to decompress a compressed bitstream 112 created by a video generator 102. The CABAC decoding module 206 includes a macroblock type decoding module 208 that when executed causes the processor 202 to decode a macroblock type syntax element from the encoded video bitstream 112. The macroblock type decoding module 208 includes a set of rules that guide the decoding of macroblock type syntax elements. In some embodiments, the macroblock type decoding rules are included in the instructions of the macroblock type decoding module 208. In other embodiments, the macroblock type decoding rules are included in a set of one or more macroblock type decoding tables 210. The tables 210 are accessed by the instructions of the macroblock type decoding module 208 to direct the flow of macroblock type decoding.

Tables 1 and 2 below show the macroblock type binarization specified by the H.264 standard. Table 1 defines macroblock type binarization for 1 slice macroblock types. Macroblock types in SI slices add a single bit prefix to a binary value of Table 1. Table 2 defines macroblock type binarization for P, SP, and B slice macroblock types. I macroblock types in P, and SP slices (values 5-30), and B slices (values 23-48) add the corresponding binary prefixes of Table 2 to a binary value of Table 1.

The I slice macroblock types of Table 1 include binary values that are 1, 2, 6, or 7 bits in length. The macroblock type decoding module 208 decodes a macroblock type from the bitstream 112 a bit at a time and inserts each bit into a binary value including previous decoded bits. For each bit decoded, the binary value, and in some embodiments, the number of bits decoded are processed through the rules to generate information related to the progress of the decoding process. For example, after decoding the first bit of an I slice macroblock type, the rules are applied to the binary value. If the value is zero, decoding is complete and a macroblock type value of “0” is indicated. If the value of the first decoded bit is “1,” a second bit is decoded and inserted as the least significant bit of the binary value. If the value of the two decoded bits is “11,” then decoding is complete, and a macroblock type value of 25 is indicated. If the value of the two decoded bits is “10,” then at least four additional bits must be decoded. If the value of the third and fourth bits decoded are “01” or “11,” then the determination of the macroblock type symbol requires decoding of a total of seven bits. These rules for determining the exit point of a macroblock type decoding loop can be encoded in instructions that execute each loop iteration, or in the table 210. The table 210 can be addressed using the binary value as presently (e.g., partially or completely) decoded. For example, addressing the table 210 based on a macroblock type binary value of “0,” “11,” “1000xx,” “1010xx,” or a seven bit value can return a value indicating that decoding is complete and/or indicating the value of the macroblock symbol (e.g., 0-25).

The table 210 may also include rule information guiding the macroblock type decoding module 208 in application of a context model to decoding of additional bits. A different context model may be applied to decode each successive bit. However, the context applied to a given bit index may differ based on the value of bits previously decoded and/or the number of bits remaining to be decoded. For example, context models W, X, Y, and Z may be respectively applied to decoding the fourth, fifth, sixth and seventh bits of a seven bit macroblock type binary, while contexts W, Y, and Z may be respectively applied to decoding the fourth, fifth, and sixth bits of a six bit macroblock type binary. A value indicating which context model to apply can be returned from the table 210 based on the present value of the bits used to address the table. Using the example above, if the table 210 is addressed using “1000,” or “1010” the table 210 can provide a value indicating that context Y rather than context X should be used to decode a next bit.

In some embodiments, the table 210 may return a value indicative of a number of additional bits to decode prior to the next table access. For example, when addressed with the value “11,” the table 210 may return a value indicating that two additional bits should be decoded prior to the next table 210 access. In such embodiments, context model selection is predictable and predetermined so no table 210 access is required to determine a context to apply to the fourth bit decoded. Such an embodiment may be beneficial if the table 210 access overhead is greater that the overhead of skipping the table 210 access.

The table 210 may include tables corresponding to each slice type. Thus, one embodiment of the table 210 may include different tables for I, P, and B slice types. The tables for macroblock types of each slice type may include decode termination, symbol value, context, and additional bit indications as described above.

TABLE 1
Binarization for macroblock types in I slices

| Value (name) of mb_type | Bin string | | | | | | |
|---|---|---|---|---|---|---|---|
| 0 (I_4×4) | 0 | | | | | | |
| 1 (I_16×16_0_0_0) | 1 | 0 | 0 | 0 | 0 | 0 | |
| 2 (I_16×16_1_0_0) | 1 | 0 | 0 | 0 | 0 | 1 | |
| 3 (I_16×16_2_0_0) | 1 | 0 | 0 | 0 | 1 | 0 | |
| 4 (I_16×16_3_0_0) | 1 | 0 | 0 | 0 | 1 | 1 | |
| 5 (I_16×16_0_1_0) | 1 | 0 | 0 | 1 | 0 | 0 | 0 |
| 6 (I_16×16_1_1_0) | 1 | 0 | 0 | 1 | 0 | 0 | 1 |
| 7 (I_16×16_2_1_0) | 1 | 0 | 0 | 1 | 0 | 1 | 0 |
| 8 (I_16×16_3_1_0) | 1 | 0 | 0 | 1 | 0 | 1 | 1 |
| 9 (I_16×16_0_2_0) | 1 | 0 | 0 | 1 | 1 | 0 | 0 |
| 10 (I_16×16_1_2_0) | 1 | 0 | 0 | 1 | 1 | 0 | 1 |
| 11 (I_16×16_2_2_0) | 1 | 0 | 0 | 1 | 1 | 1 | 0 |
| 12 (I_16×16_3_2_0) | 1 | 0 | 0 | 1 | 1 | 1 | 1 |
| 13 (I_16×16_0_0_1) | 1 | 0 | 1 | 0 | 0 | 0 | |
| 14 (I_16×16_1_0_1) | 1 | 0 | 1 | 0 | 0 | 1 | |
| 15 (I_16×16_2_0_1) | 1 | 0 | 1 | 0 | 1 | 0 | |
| 16 (I_16×16_3_0_1) | 1 | 0 | 1 | 0 | 1 | 1 | |
| 17 (I_16×16_0_1_1) | 1 | 0 | 1 | 1 | 0 | 0 | 0 |
| 18 (I_16×16_1_1_1) | 1 | 0 | 1 | 1 | 0 | 0 | 1 |
| 19 (I_16×16_2_1_1) | 1 | 0 | 1 | 1 | 0 | 1 | 0 |
| 20 (I_16×16_3_1_1) | 1 | 0 | 1 | 1 | 0 | 1 | 1 |
| 21 (I_16×16_0_2_1) | 1 | 0 | 1 | 1 | 1 | 0 | 0 |
| 22 (I_16×16_1_2_1) | 1 | 0 | 1 | 1 | 1 | 0 | 1 |
| 23 (I_16×16_2_2_1) | 1 | 0 | 1 | 1 | 1 | 1 | 0 |
| 24 (I_16×16_3_2_1) | 1 | 0 | 1 | 1 | 1 | 1 | 1 |
| 25 (I_PCM) | 1 | 1 | | | | | |
| binIdx | 0 | 1 | 2 | 3 | 4 | 5 | 6 |

TABLE 2
Binarization for macroblock types in P, SP, and B slices

| Slice type | Value (name) of mb_type | Bin string | | | | | | |
|---|---|---|---|---|---|---|---|---|
| P, SP slice | 0 (P_L0_16×16) | 0 | 0 | 0 | | | | |
| | 1 (P_L0_L0_16×8) | 0 | 1 | 1 | | | | |
| | 2 (P_L0_L0_8×16) | 0 | 1 | 0 | | | | |
| | 3 (P_8×8) | 0 | 0 | 1 | | | | |
| | 4 (P_8×8ref0) | na | | | | | | |
| | 5 to 30 (Intra, prefix only) | 1 | | | | | | |
| B slice | 0 (B_Direct_16×16) | 0 | | | | | | |
| | 1 (B_L0_16×16) | 1 | 0 | 0 | | | | |
| | 2 (B_L1_16×16) | 1 | 0 | 1 | | | | |
| | 3 (B_Bi_16×16) | 1 | 1 | 0 | 0 | 0 | 0 | |
| | 4 (B_L0_L0_16×8) | 1 | 1 | 0 | 0 | 0 | 1 | |
| | 5 (B_L0_L0_8×16) | 1 | 1 | 0 | 0 | 1 | 0 | |
| | 6 (B_L1_L1_16×8) | 1 | 1 | 0 | 0 | 1 | 1 | |
| | 7 (B_L1_L1_8×16) | 1 | 1 | 0 | 1 | 0 | 0 | |
| | 8 (B_L0_L1_16×8) | 1 | 1 | 0 | 1 | 0 | 1 | |
| | 9 (B_L0_L1_8×16) | 1 | 1 | 0 | 1 | 1 | 0 | |
| | 10 (B_L1_L0_16×8) | 1 | 1 | 0 | 1 | 1 | 1 | |
| | 11 (B_L1_L0_8×16) | 1 | 1 | 1 | 1 | 1 | 0 | |
| | 12 (B_L0_Bi_16×8) | 1 | 1 | 1 | 0 | 0 | 0 | 0 |
| | 13 (B_L0_Bi_8×16) | 1 | 1 | 1 | 0 | 0 | 0 | 1 |
| | 14 (B_L1_Bi_16×8) | 1 | 1 | 1 | 0 | 0 | 1 | 0 |
| | 15 (B_L1_Bi_8×16) | 1 | 1 | 1 | 0 | 0 | 1 | 1 |
| | 16 (B_Bi_L0_16×8) | 1 | 1 | 1 | 0 | 1 | 0 | 0 |
| | 17 (B_Bi_L0_8×16) | 1 | 1 | 1 | 0 | 1 | 0 | 1 |
| | 18 (B_Bi_L1_16×8) | 1 | 1 | 1 | 0 | 1 | 1 | 0 |
| | 19 (B_Bi_L1_8×16) | 1 | 1 | 1 | 0 | 1 | 1 | 1 |
| | 20 (B_Bi_Bi_16×8) | 1 | 1 | 1 | 1 | 0 | 0 | 0 |
| | 21 (B_Bi_Bi_8×16) | 1 | 1 | 1 | 1 | 0 | 0 | 1 |
| | 22 (B_8×8) | 1 | 1 | 1 | 1 | 1 | 1 | |
| | 23 to 48 (Intra, prefix only) | 1 | 1 | 1 | 1 | 0 | 1 | |

| | | | | | | | |
|---|---|---|---|---|---|---|---|
| binIdx | 0 | 1 | 2 | 3 | 4 | 5 | 6 |

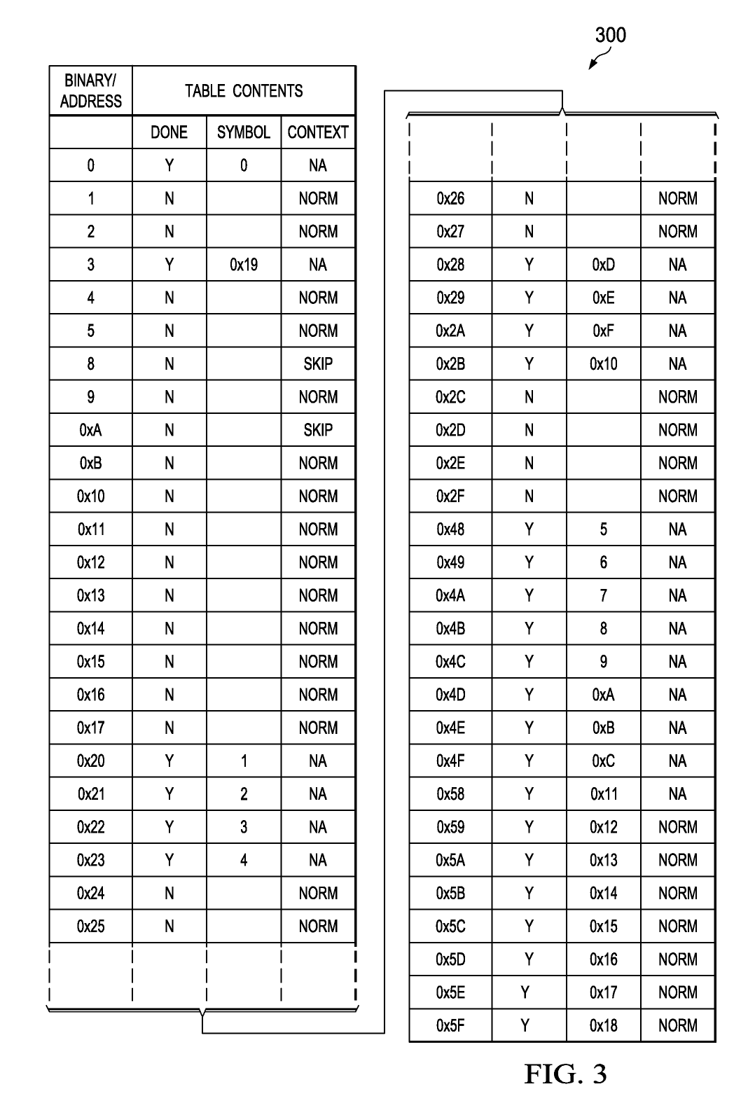

FIG. 3 shows at least a portion of the macroblock type decoding table 210 in accordance with various embodiments. The table embodies rules for guiding macroblock type decoding, and different embodiments may be configured in various ways. The embodiment of FIG. 3 is configured for access using right justified binary values, and shows only table entries corresponding to values compliant with decoding a macroblock type binary as given in Table 1. Table entries corresponding to non-compliant (erroneous) binary values are not shown. The table 210 of FIG. 3 provides a decoding done (decode termination) indication, a macroblock type symbol indication, and context update indication for each decoded and partially decoded macroblock type binary used to address the table. Some embodiments may include only some of the illustrated table contents. Some embodiments may include different table contents, such as additional bits to decode.

While FIG. 3 shows only portion of the table 210 corresponding to the I slice macroblock types of Table 1, those skilled in the art will understand that corresponding data tables can be constructed for the B and P slice macroblock types of Table 2. In some embodiments, a rules table may be addresses using the partially decoded syntax element binary value with a “1” prefix. For example, a “1” prefix may be added to a binary value for a P/SP macroblock type (as shown in Table 2 above) and/or a P/SP sub-macroblock to allow easy identification of leading zeros of a syntax element.

By using the macroblock type decoding table 210 to control termination of a decoding loop, the decoder 200 can implement a software pipelined decoding loop, and consequently provide more efficient decoding than is possible using tree traversal methods which can require numerous context changes.

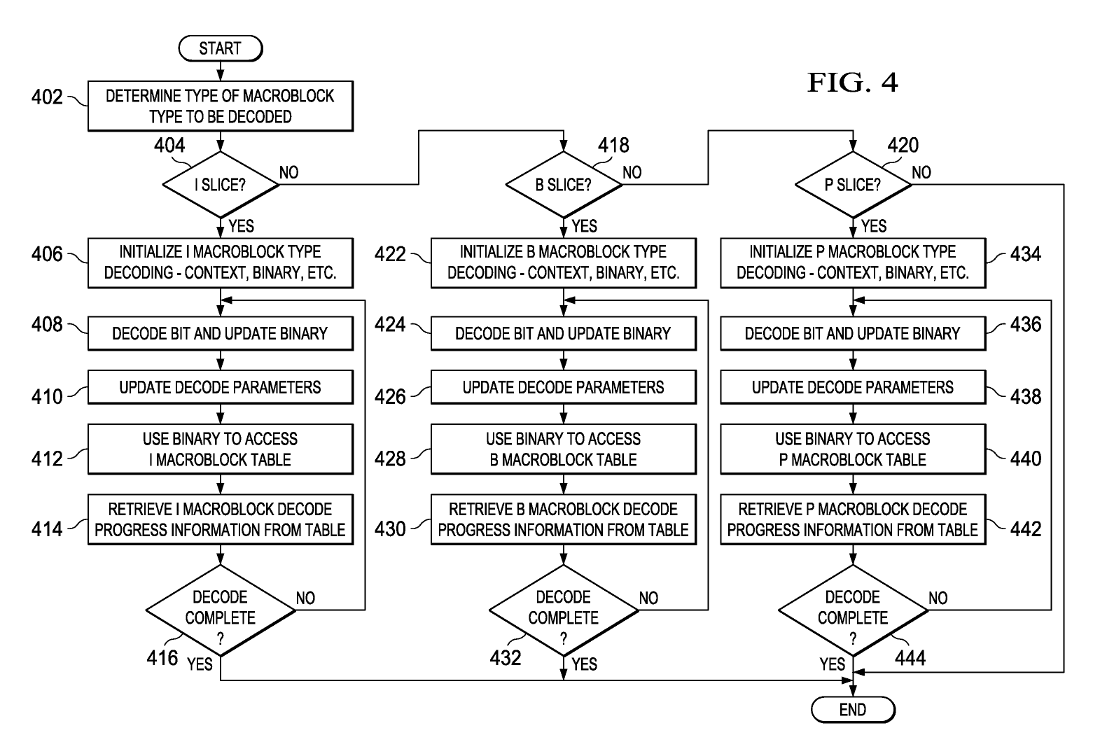

FIG. 4 shows a flow diagram for a method for CABAC macroblock type decoding in accordance with various embodiments. Though depicted sequentially as a matter of convenience, at least some of the actions shown can be performed in a different order and/or performed in parallel. Additionally, some embodiments may perform only some of the actions shown. In some embodiments, the operations of FIG. 4, as well as other operations described herein, can be implemented as instructions stored in a computer-readable medium (e.g., storage 204) and executed by a processor (e.g., processor 202).

In block 402, the CABAC decoder 200 is running. The processor 202 is executing instructions provided from the CABAC decoding module 206 stored in the program/data storage 204. The CABAC decoding module 206 may implement software pipelining. Consequently, the processor 202 may be simultaneously executing portions of a macroblock type decoding loop applicable to more that one bit of a macroblock type being decoded. The processor 202 determines the type of slice containing the macroblock type syntax element to be decoded. In some embodiments, the type of slice determines what portion of the macroblock type decoding tables 210 is applied to guide macroblock type decoding.

If, in block 404, the processor 202 determines that the macroblock type syntax element to be decoded is in an I slice, then the processor 202 initializes I slice macroblock type decoding in block 406. Initialization may include selecting a context model to be used in decoding of a first bit, initializing storage for the macroblock type binary, etc.

In block 408, processor 202 extracts a compressed bit from the bitstream 112, and inserts the bit in the macroblock type binary. The bit may be inserted by left shifting the current value of the macroblock type binary and inserting the bit in the position vacated by the shift (i.e., the least significant bit).

In block 410, the processor 202 updates decoding parameters. For example, the value and range of most and/or least probable symbol may be adjusted.

In block 412, the processor 202 uses the macroblock type binary to access the portion of the macroblock type decoding tables 210 used to decode I slice macroblock types.

In block 414, the processor retrieves from the tables 210, information used to guide the macroblock type decoding process, such as decode completion status, symbol information, context information, etc. Some embodiments apply retrieved context information to identify a context model to be applied to decoding a next bit.

In block 416, the processor determines, based on the decode completion status, whether the macroblock type decoding is complete. If incomplete, then decoding continues in block 408.

If, in block 404, the processor 202 determines that the macroblock type syntax element to be decoded in not in an I slice, then processor 202 checks for a B slice in block 418. If the slice is a B slice, then the processor 202 performs the operations of blocks 422-432 (in fashion similar to that explained with regard to blocks 406-416) to decode the macroblock type. In block 428, the processor 202 uses the macroblock type binary to access the portion of the macroblock type decoding tables 210 used to decode B slice macroblock types.

If, in block 418, the processor 202 determines that the macroblock type syntax element to be decoded in not in a B slice, then processor 202 checks for a P slice in block 420. If the slice is a P slice, then the processor 202 performs the operations of blocks 434-444 (in fashion similar to that explained with regard to blocks 406-416) to decode the macroblock type. In block 440, the processor 202 uses the macroblock type binary to access the portion of the macroblock type decoding tables 210 used to decode P slice macroblock types.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A video decoding system, comprising:
a context adaptive binary arithmetic code (“CABAC”) decoder, comprising:
a processor; and
decode logic executed by the processor, the decode logic configured to decompress a CABAC encoded syntax element, the decode logic comprising:
a table embodying a set of rules that determine whether syntax element decoding is complete based on table addressing derived from a decoded syntax element binary value.

2. The video decoding system of claim 1, wherein the syntax element is one of a macroblock type, a submacroblock type, chroma prediction mode, and intra prediction mode.

3. The video decoding system of claim 1, wherein the syntax element binary value is a partially decoded syntax element binary value.

4. The video decoding system of claim 1, wherein the table provides an indication of a number of additional bits to decode for a given partially decoded syntax element binary value.

5. The video decoding system of claim 1, wherein the table provides a representation of a syntax element symbol based on addressing the table with a fully decoded syntax element binary value.

6. The video decoding system of claim 1, wherein the table provides information indicative of a context to be applied in decoding a next bit of the syntax element binary value.

7. The video decoding system of claim 1, wherein the processor is a very long instruction word processor and the decode logic is configured to concurrently decode a plurality of bits of a given CABAC encoded syntax element.

8. The video decoding system of claim 1, wherein the table is directed to I slice macroblock types and the decode logic further includes additional tables directed to P, and B slice macroblock types, wherein the additional tables each embody a set of rules that determine whether macroblock decoding is complete for a given decoded macroblock type binary value of the respective slice type.

9. A method, comprising:
determining, by one or more processors, a type of syntax element to be decoded from a context adaptive binary arithmetic code (“CABAC”) encoded bitstream;
decoding a bit from the bitstream based on the determined type of syntax element;
generating a syntax element binary value based on the decoded bit; and
retrieving an indication of syntax element decoding completion from a table embodying rules for determining whether syntax element decoding is complete based on a sequence of decoded syntax element bits.

10. The method of claim 9, further comprising retrieving from the table, a number of additional bits to decode to continue decoding of the syntax element binary value.

11. The method of claim 9, further comprising retrieving from the table, a syntax element symbol based on accessing the table based on a completely decoded syntax element binary value.

12. The method of claim 9, further comprising retrieving from the table an indication of a context model to be applied for decoding a next bit of the syntax element binary value from the bitstream.

13. The method of claim 9, further comprising providing from the table, based on a decoded syntax element binary address value, a value indicating that the syntax element decoding is complete based on:
the determined type of syntax element being an I slice macroblock type, and any of:
one bit being decoded and the one decoded bit being a zero;
two bits being decoded and both of the two decoded bits being a one;
six bits being decoded and a fourth of the six decoded bits being a zero; and
seven bits being decoded.

14. The method of claim 9, further comprising providing from the table, based on a decoded syntax element binary value, a value indicating that a context applied in decoding a sixth bit of a seven bit syntax element binary value be applied to a fifth bit of a six bit syntax element binary value.

15. The method of claim 9, wherein the syntax element is one of a macroblock type, a submacroblock type, a chroma prediction mode, and an intra prediction mode.

16. A computer readable medium encoded with a computer program that when executed causes a processor to:
determine a type of syntax element to be decoded from a context adaptive binary arithmetic code (“CABAC”) encoded bitstream;
decode a bit from the bitstream based on the determined type of syntax element;
generate a syntax element binary based on the decoded bit; and
retrieve an indication of syntax element decoding completion from a table embodying rules for determining whether syntax element decoding is complete based on a sequence of decoded syntax element bits.

17. The computer readable medium of claim 16, wherein the program causes the processor to retrieve from the table, a number of additional bits to decode to complete decoding of the syntax element binary.

18. The computer readable medium of claim 16, wherein the program causes the processor to retrieve from the table, a syntax element symbol based on accessing the table based on a completely decoded syntax element binary.

19. The computer readable medium of claim 16, wherein the program causes the processor to retrieve from the table an indication of a context model to be applied for decoding a next bit of the syntax element binary from the bitstream.

20. The computer readable medium of claim 16, wherein the program causes the processor to concurrently decode a plurality of bits of the syntax element binary.

21. The computer readable medium of claim 16, wherein the program causes the processor to retrieve from the table a value indicating that the syntax element decoding is complete based on any of:
the determined type of syntax element being an I slice macroblock type, and any of:
one bit being decoded and the one decoded bit being a zero;
two bits being decoded and both of the two decoded bits being a one;
six bits being decoded and a fourth of the six decoded bits being a zero; and
seven bits being decoded;
the determined type of syntax element being an P slice macroblock, and three bits being decoded and a first of the decoded bits being a zero; and
the determined type of syntax element being a B slice macroblock, and any of:
one bit being decoded and the one decoded bit being a zero;
three bits being decoded and the second decoded bit being a zero;
six bits being decoded and a third of the six decoded bits being a zero;
six bits being decoded and only a sixth of the six decoded bits being a zero; and
seven bits being decoded.
